(19) United States
(12) Patent Application Publication
(10) Pub. No.: US 2026/0195234 A1
(43) Pub. Date: Jul. 9, 2026

(54) MODEL EVALUATION

(71) Applicant: INTERNATIONAL BUSINESS MACHINES CORPORATION, ARMONK, NY (US)

(72) Inventors: Zhong Fang Yuan, Xi'an (CN); Tong Liu, Xi'an (CN); Li Juan Gao, Xi'an (CN); Chen Gao, Xi'an (CN)

(21) Appl. No.: 19/012,384

(22) Filed: Jan. 7, 2025

(51) Int. Cl. G06F 11/34

(52) U.S. Cl. CPC G06F 11/3447

(57) ABSTRACT

A method, computer system, and a computer program product for model evaluation is provided. The present invention may include generating, by a first model, a first tree of thoughts for evaluating capabilities of second model that answers a user query, wherein the first tree of thoughts includes a plurality of nodes, each node of which indicates a solution to a task among a plurality of tasks for the evaluating. The present invention may include outputting an evaluation report based on at least part of solutions corresponding to the plurality of nodes.

### TECHNICAL FIELD

The present disclosure relates to artificial intelligence models, and more specifically, to a method, system, and computer program product for model evaluation.

### BACKGROUND

Artificial intelligence models, especially large models such as large language models (LLMs), are gaining increasing popularity in both academia and industry, owing to their unprecedented performance in various applications. As large models continue to play a vital role in both research and daily use, their evaluation becomes increasingly critical, not only at the task level, but also at the society level for better understanding of their potential risks.

First, evaluating large models helps us better understand the strengths and weakness of large models. Second, better evaluations can provide better guidance for human-large models interaction, which could inspire future interaction design and implementation. Third, the broad applicability of large models underscores the paramount importance of ensuring their safety and reliability, particularly in safety-sensitive sectors such as financial institutions and healthcare facilities.

### SUMMARY

According to one embodiment of the present disclosure, there is provided a computer-implemented method for model evaluation. In this method, a first tree of thoughts for evaluating capabilities of a second model that answers a user query is generated by a first model. The first tree of thoughts includes a plurality of nodes, each node of which indicates a solution to a task among a plurality of tasks for the evaluating, and the plurality of tasks are generated by the first model and at least a portion of the plurality of tasks is to be accomplished by solutions generated by the first model. In response to the first model being not capable of accomplishing a first task among the plurality of tasks independently, a tool is invoked from a tool pool by the first model to generate a first solution to the first task. An evaluation report is outputted based on at least part of solutions corresponding to the plurality of nodes.

According to another embodiment of the present disclosure, there is provided a system for model evaluation. The system comprises one or more processors, a memory coupled to at least one of the processors and a set of computer program instructions stored in the memory. When executed by at least one of the processors, the set of computer program instructions perform the action of generating, by a first model, a first tree of thoughts for evaluating capabilities of a second model that answers a user query. The first tree of thoughts includes a plurality of nodes, each node of which indicates a solution to a task among a plurality of tasks for the evaluating, and the plurality of tasks are generated by the first model and at least a portion of the plurality of tasks is to be accomplished by the first model to generate solutions thereto. When executed by at least one of the processors, the set of computer program instructions further perform the action of outputting an evaluation report based on at least part of solutions corresponding to the plurality of nodes. In response to the first model being not capable of accomplishing a first task among the plurality of tasks independently, a tool is invoked from a tool pool by the first model to generate a first solution to the first task.

According to yet another embodiment of the present disclosure, there is provided a computer program product for model evaluation. The computer program product comprises a non-transitory computer readable storage medium having program instructions embodied therewith. The program instructions are executable by a processor to cause the processor to perform the action of generating, by a first model, a first tree of thoughts for evaluating capabilities of a second model that answers a user query. The first tree of thoughts includes a plurality of nodes, each node of which indicates a solution to a task among a plurality of tasks for the evaluating, and the plurality of tasks are generated by the first model and at least a portion of the plurality of tasks is to be accomplished by the first model to generate solutions thereto. In response to the first model being not capable of accomplishing a first task among the plurality of tasks independently, a tool is invoked from a tool pool by the first model to generate a first solution to the first task. The program instructions are executable by a processor to cause the processor to further perform the action of outputting an evaluation report based on at least part of solutions corresponding to the plurality of nodes.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computing environment which is applicable to implement the embodiments of the present disclosure;

FIG. 2 shows an exemplary schematic diagram of model evaluation in a scenario of instruction generation for process automation according to an embodiment of the present disclosure;

FIG. 3 shows an exemplary schematic diagram of creating a real-time prompt template according to an embodiment of the present disclosure;

FIG. 4 shows an exemplary schematic diagram of selecting prompt templates by Tree of Thought (ToT) according to an embodiment of the present disclosure;

FIG. 5 shows an exemplary schematic diagram of filling slots of prompt templates according to an embodiment of the present disclosure;

FIG. 6 shows another exemplary schematic diagram of filling slots of prompt templates according to an embodiment of the present disclosure;

FIG. 7 shows an exemplary schematic diagram of an example ToT according to an embodiment of the present disclosure;

FIG. 8 shows an exemplary schematic diagram of model evaluation interface in an example of instruction generation according to an embodiment of the present disclosure;

FIG. 9 shows an exemplary schematic diagram of results in the evaluation dimensions of FIG. 8;

FIG. 10 shows a flowchart of a computer-implemented method of model evaluation according to an embodiment of the present disclosure; and

FIG. 11 shows a system of model evaluation according to an embodiment of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums includes: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described previously, Artificial intelligence models, especially large models such as large language models (LLMs), are gaining increasing popularity in both academia and industry, owing to their unprecedented performance in various applications. As large models continue to play a vital role in both research and daily use, their evaluation becomes increasingly critical, not only at the task level, but also at the society level for better understanding of their potential risks.

First, evaluating large models helps us better understand the strengths and weakness of large models. Second, better evaluations can provide better guidance for human-large models interaction, which could inspire future interaction design and implementation. Third, the broad applicability of large models underscores the paramount importance of ensuring their safety and reliability, particularly in safety-sensitive sectors such as financial institutions and healthcare facilities.

Therefore, it may be advantageous to, amongst other things, generate, by one or more processing units, a first tree of thoughts with a first model, wherein the first tree of thoughts is for evaluating capabilities of a second model that answers a user query, and the first tree of thoughts includes a plurality of nodes, each node of which indicates a solution to a task among a plurality of tasks for the evaluating, and the plurality of tasks are generated by the first model and at least a portion of the plurality of tasks is to be accomplished by the first model to generate solutions thereto (e.g., accomplished by solutions generated by the first model), and output, by one or more processing units, an evaluation report based on at least part of solutions corresponding to the plurality of nodes, wherein generating a first tree of thoughts comprises: in response to the first model being not capable/incapable of accomplishing a first task among the plurality of tasks independently, invoking, by one or more processing units, a tool from a tool pool with the first model to generate a first solution to the first task.

According at least one embodiment, the present invention may improve model evaluation by improving over the traditional benchmark testing methods which are typically encompassed by two approaches. The approach may typically involve using test data for evaluation, primarily applied to traditional Natural Language Processing (NLP) tasks like classification and entity recognition. The second approach typically relied on employing a third-party model to assess the performance of other models. In this approach, evaluators may utilize a third-party model with a specialized prompt to evaluate the outputs generated by the one or more other large models. However, both of these methods exhibit inherent limitations. They struggle to offer flexible and real-time evaluations of large models, especially in the context of specific vertical industries and aligning with dynamic customer requirements in real business scenarios. Evaluating the abilities of large models within real-world scenarios poses a challenging endeavor for several reasons, including, but not limited to including, there is no universally applicable dataset specifically tailored to each unique scenario, and given the multitude of potential scenarios, creating custom datasets for each one may not be feasible. Furthermore, these scenarios often remain foreign to any third-party model. Consequently, third-party large models may only be capable of providing benign yet inaccurate evaluations, failing to assess the quality of results accurately.

According to at least one embodiment, the present invention may improve model evaluation by proposing a LLM evaluation method based on Tool-learning and Tree of Thought. The invention may use third-party large models to evaluate the output of other models, but this evaluation method is more refined that the traditional methods described above. Instead of the approach outlined for the traditional methods above, the invention uses the third-party large model to independently determine the domain to which the model belongs during evaluation, and then a thinking evaluation tree is generated based on the specific domain. This thinking evaluation tree is jointly obtained from the retrieval results and the real-time generation results of the model.

According to at least one embodiment, the present invention may improve model evaluation by jointly disassembling the Tree of Thought and the problems that need to be evaluated. Dividing the problems that need to be evaluated into multiple sub-questions and attributing them to nodes of the Tree of Thought.

According to at least one embodiment, the present invention may improve model evaluation by for each node of the Tree of Thought, the invention judges whether the sub-question represented by this node can be answered by the large model independently. If it can be answered independently, the invention lets the large model answer independently and generates a result. If the large model cannot answer independently, the large model is allowed to use a third-party tool on this node, and the large model generates the result after calling the third-party tool. Finally, the invention combines and summarizes these results, and the summarized results are provided to the large model to generate a complete report.

According to at least one embodiment, the present invention may improve model evaluation by addressing the limitations of traditional benchmark testing methods and the need for more flexible and real-time evaluation approaches for large language models, particularly in the context of specific industries and evolving customer requirements. The invention enables more accurate assessments of large model performance in real-world, industry-specific scenarios, which may lead to improved model utility and applicability.

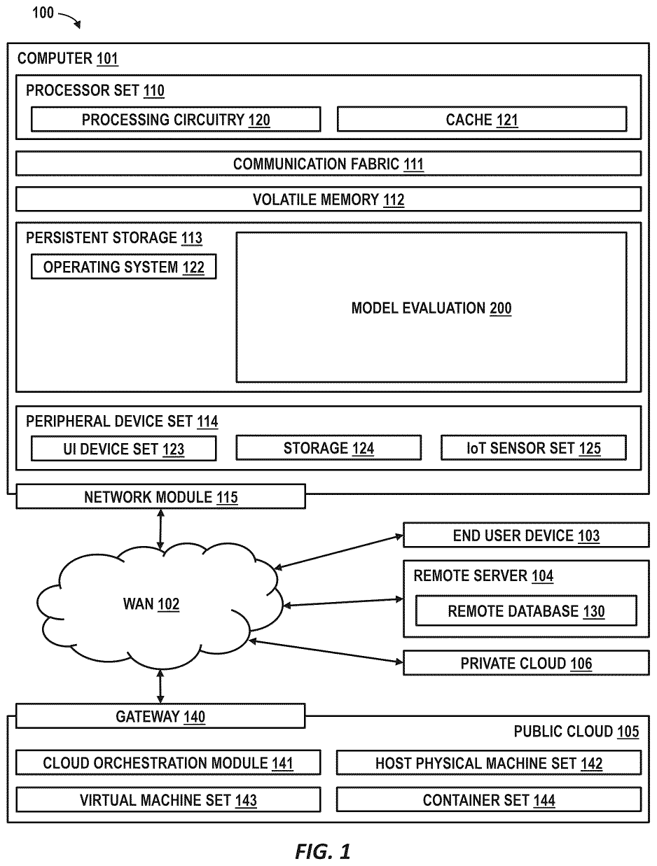

Referring to FIG. 1, Computing environment 100 contains an example of an environment for the execution of at least some of the computer code involved in performing the inventive methods, such as model evaluation 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

It is understood that the computing environment 100 in FIG. 1 is only provided for illustration purpose without suggesting any limitation to any embodiment of this disclosure, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device 114 could also be implemented by an independent peripheral device connected to the computer 101 through interface. For a further example, the WAN may be replaced and/or supplemented by any other connection made to an external computer (for example, through the Internet using an Internet Service Provider).

As mentioned above, model evaluation becomes increasingly critical. Currently, there are two main testing method for evaluating models, specifically the upper limit of their capabilities (also referred to as benchmark). One method is to use test data to evaluate capabilities of large models for traditional Natural Language Processing (NLP) tasks such as classification, entity recognition, summary, etc. Generally, large models would collect most of open-source test data on the market as test corpus, and thus most large models will achieve good performance in the test of open-source test data. Nevertheless, test data is generally only oriented to simple single tasks and lacks changes, which is very different from real business scenarios. Therefore, large models that perform well on open-source test data sets often perform poorly in real business scenarios.

Another method is to use a third-party large model to evaluate the results generated by other models. This method has the disadvantage that the results of the evaluation are almost dependent on the effect of the third-party model, and the evaluated performance upper limit is not for large models but for the third-party model.

These methods have their own disadvantages, and they cannot evaluate the capabilities of large models well, especially in vertical industries, flexibly and in real time in combination with customer's needs in real business scenarios. For example, when using a large language model (LLM) to act as an instruction generation robot in the process automation scenario, the LLM may accept human natural language and convert it into Systems, Applications & Products in Data Processing (SAP) instructions. It is difficult to evaluate the ability of a large model in this scenario. On the one hand, there is no single dataset constructed for this scenario, and it is impossible to build a dataset from scratch for every scenario of various scenarios in the world. On the other hand, for this scenario, it is completely unfamiliar to any third-party models, and the third-party models cannot accurately evaluate the quality of the results generated by other models and may merely provide some innocuous and inaccurate evaluations.

In view of the above, there exists a need for an improved model evaluation approach to efficiently evaluate models, thereby improving accuracy of evaluation and elevating the upper limit of evaluation capability.

Embodiments of the present disclosure aim to solve at least one of the technical problems described above, and propose a method, a system and computer program product for model evaluation. In the model evaluation approach according to embodiments of the present disclosure, a tree of thoughts for evaluating capabilities of a second model that answers a user query can be generated by a first model, such that each node of the tree of thoughts indicates a solution to a task among a plurality of tasks for the evaluating, and the plurality of tasks are generated by the first model and at least a portion of the plurality of tasks is to be accomplished by the first model to generate solutions thereto (e.g., accomplished by solutions generated by the first model). For a first task that cannot be accomplished by the first model independently, the first model may invoke a tool from a tool pool to generate a first solution to the first task. In other words, the model evaluation approach according to embodiments of the present disclosure can be based on “Tool-learning” and “Tree of Thoughts.” In such a way, multiple potential and feasible possibilities are considered, such that the evaluation is much like the thinking process of human beings, and tasks beyond the ability of the first model as the evaluating model can be solved, so as to obtain more accurate evaluation report.

It should be noted that the processing of model evaluation according to embodiments of this disclosure could be implemented in the computing environment of FIG. 1.

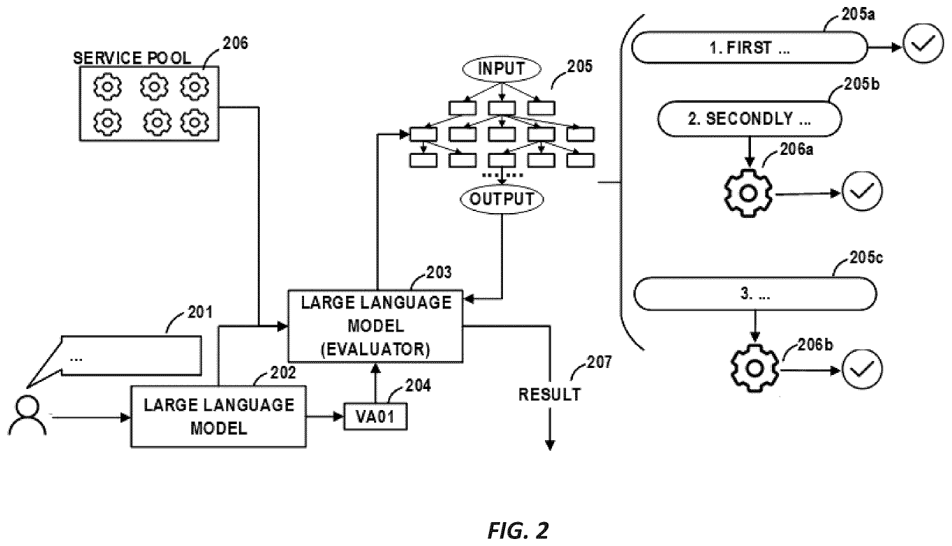

FIG. 2 shows an exemplary schematic diagram of model evaluation in a scenario of instruction generation for process automation according to an embodiment of the present disclosure.

As shown in FIG. 2, a user inputs a query to a large language model (LLM) 202. For example, the user may input a query, such as, “Help me change or create a sales order” 201 to the LLM 202. The LLM 202 may act as an instruction generation robot in the process automation scenario to convert the query into SAP instructions “VA01” 204. The SAP instructions “VA01” 204 for the query 201 are sent to a LLM 203, the LLM 203 may act as an evaluator to assess the SAP instructions “VA01” 204. The LLM 203 may generate a tree of thoughts 205. The output of the tree of thoughts 205 may be returned to the LLM 203, and the LLM 203 may output an evaluation result 207, for example “This answer is very good, stays on topic, and produces fully executable codes”, based on the output of the tree of thoughts 205.

The tree of thoughts 205 may include a plurality of nodes and several branches, and the task of evaluating the SAP instructions “VA01” 204 may be divided into multiple tasks 205a, 205b, 205c . . . . Each node of the tree of thoughts 205 corresponds to a solution to a task among the multiple tasks. When solving the multiple tasks 205a, 205b, 205c . . . , the LLM 203 may determine whether it can accomplish a task. If the LLM 203 can accomplish a task, it may solve the task. If the LLM 203 cannot accomplish a task, including it cannot generate a solution or the generated solution is improper, it may invoke a service tool from a service pool 206. For example, for the task 205a “First I need to confirm whether the language type is advanced business application programming (ABAP) in the SAP system”, the LLM 203 can accomplish it; for the task 205b “Secondly, I need to confirm whether this code is executable”, the LLM 203 cannot accomplish it and may invoke an advanced business application programming (ABAP) executor service 206a from the service pool 206 to generate a solution; and for the task 205c “I need to check whether the execution result of the code is related to the problem”, the LLM 203 cannot accomplish it and may invoke an SAP tagging service 206b from the service pool 206 to generate a solution.

In FIG. 2, the user query may be, for example, text “Help me change or create a sales order”. Nevertheless, those skilled in the art would appreciate that, in the present disclosure, the user query may comprise one or more of text, image, sound, or video, etc.

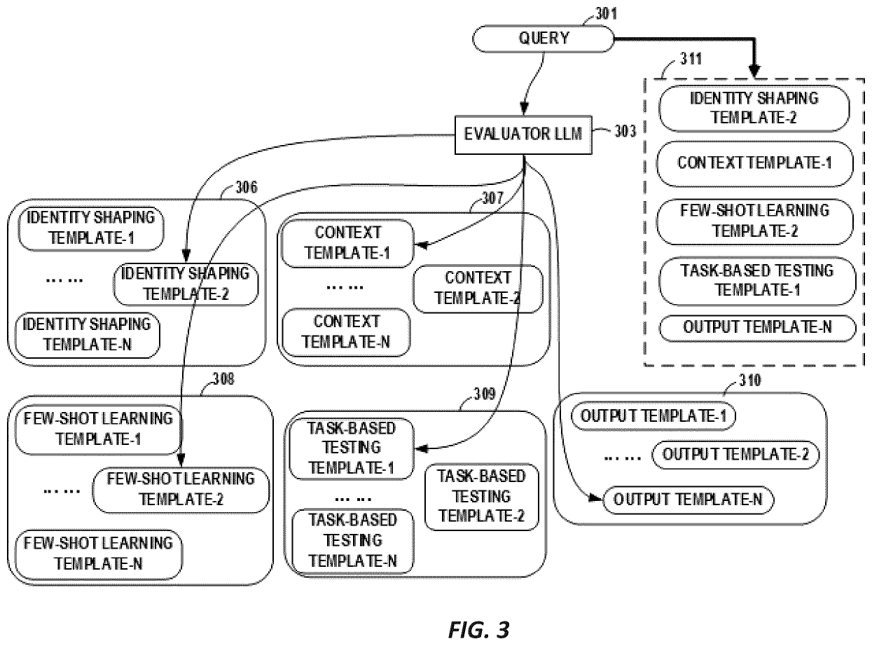

FIG. 3 shows an exemplary schematic diagram of creating a real-time prompt template according to an embodiment of the present disclosure.

As shown in FIG. 3, an evaluator LLM 303 may aim to create prompts that are more closely aligned with the user's original intent, so as to evaluate answers to the user query based on these prompts. After receiving a user query 301, the evaluator LLM 303 may utilize “Tree of Thought” technique to create a real-time prompt template 311 from a prompt template repository. The prompt template repository may consist of a number of sub-repositories of different types. While FIG. 3 illustrates five template sub-repositories of different types, this is not meant to be seen as limiting. In FIG. 3 the five template sub-repositories may include for example identity shaping module 306, contextual information module 307, few-shot learning module 308, task-based testing module 309 and output module 310. Each sub-repository may consist of a series of prompt templates for different application domains.

The identity shaping module 306 may consist of a series of identity templates, for example, IDENTITY SHAPING TEMPLATE-1, IDENTITY SHAPING TEMPLATE-2, . . . , IDENTITY SHAPING TEMPLATE-N. An identity shaping template aims to shape task identification. An exemplary format of an identity shaping template may be as follows: “You are a {determined based on input}, and your task is to {determined based on input}.” The contextual information module 307 may consist of a series of contextual templates, for example, CONTEXT TEMPLATE-1, CONTEXT TEMPLATE-2, . . . , CONTEXT TEMPLATE-N.

A contextual template may aim to define how to provide context information. An exemplary format of a contextual template may be as follows: “To complete your task, there is some background information you might need to know. This background information is {determined based on input}.” The few-shot learning module 308 may consist of a series of few-shot learning templates, for example, FEW-SHOT LEARNING TEMPLATE-1, FEW-SHOT LEARNING TEMPLATE-2, . . . , FEW-SHOT LEARNING TEMPLATE-N.

A few-shot learning template may aim to provide examples on how to answer the user query. An exemplary format of a few-shot learning template may be as follows: “To complete the task, I can provide you with some examples. For example, given input: {determined based on input}, you should output: {determined based on output}, . . . (the number of samples depends on the requirements).” The task-based testing module 309 may consist of a series of task-based testing templates, for example, TASK-BASED TESTING TEMPLATE-1, TASK-BASED TESTING TEMPLATE-2, . . . , TASK-BASED TESTING TEMPLATE-N.

A task-based testing template may aim to provide various tasks to finally assess the result generated by the LLM to be evaluated in various dimensions. The output module 310 may consist of a series of output templates, for example, OUTPUT TEMPLATE-1,OUTPUT TEMPLATE-2, . . . , OUTPUT TEMPLATE-N. An output template may aim to provide output format: “determined based on output.” As seen from the above, each of these templates in the sub-repositories includes at least one slot to be filled, for example “{determined based on input}” and “{determined based on input}” in the exemplary identity shaping template, “{determined based on input}” in the exemplary contextual template, “{determined based on input}” and “{determined based on output}” in the exemplary few-shot learning template, and so on.

The evaluator LLM 303 may select a prompt template from each module to generate a real-time prompt template 311, including IDENTITY SHAPING TEMPLATE-2, CONTEXT TEMPLATE-1, FEW-SHOT LEARNING TEMPLATE-2, TASK-BASED TESTING TEMPLATE-1 and OUTPUT TEMPLATE-N, without slot filling. This prompt template 311 can be seen as a customized test paper tailored to the current testing scenario for the large model.

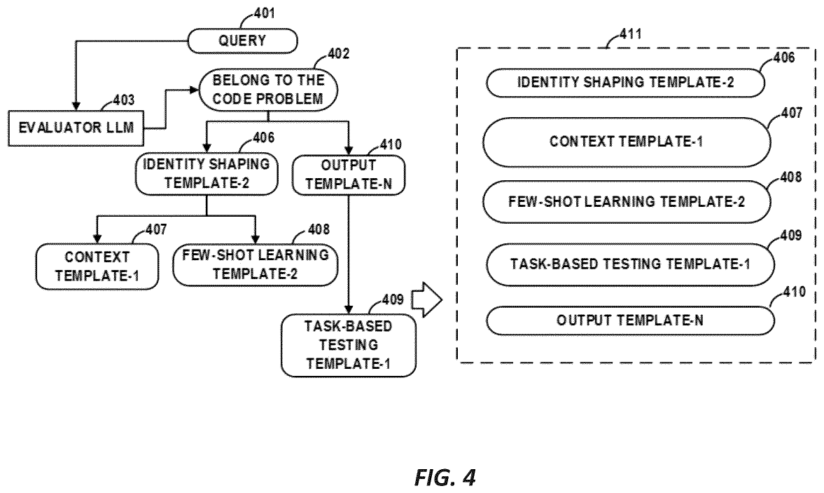

With reference to FIG. 3, it is described that for each query, utilizing different parts of the LMM's ToT to select prompt templates from the prompt template repository in real-time, composing a real-time prompt template 311. It should be noted that IDENTITY SHAPING TEMPLATE-2, CONTEXT TEMPLATE-1, FEW-SHOT LEARNING TEMPLATE-2, TASK-BASED TESTING TEMPLATE-1 and OUTPUT TEMPLATE-N each may be deemed as a single template, and they may compose an overall template together. Now with reference to FIG. 4, a detailed description on how LLM's ToT technique is employed to select prompt templates.

FIG. 4 shows an exemplary schematic diagram of selecting prompt templates by Tree of Thought (ToT) according to an embodiment of the present disclosure.

As shown in FIG. 4, after receiving a user query 401, the evaluator LLM 403 may determine a domain 402. The evaluator LLM may determine the domain 402 (“BELONG TO THE CODE PROBLEM” in the example of FIG. 4) to which the model to be evaluated belongs based on the user query 401. Then, the evaluator LLM 403 may generate a tree of thoughts based on the user query 401 and the domain 402. Specifically, when coping with a code generation test problem, the evaluator LLM 403 may not approach this test problem by directly assembling a fixed template, which may be done by traditional approaches. Instead, the evaluator LLM 403 may break down the problem into multiple distinct intentions (e.g., engaging in a series of “associations” within the context combining the user query 401 and information on prompt templates stored in the prompt template repository) and may select prompt templates based on these different intentions. This may ensure that the selected prompts are entirely in line with real query scenarios, rather than being rigidly embedded templates. This approach may offer greater business relevance compared to conventional methods.

In particularly, the evaluator LLM 403 may select an identity template from the identity shaping module 306 based on the user query, select a contextual template from the contextual information module 307, select a few-shot learning template from the few-shot learning module 308, select an output template from the output module 310, and select a task-based testing template from the task-based testing module 309.

As shown in FIG. 4, the selection of contextual template and the selection of few-shot learning template are based on the selected identity template 406 (IDENTITY SHAPING TEMPLATE-2), and the selection of task-based testing template may be based on the selected output template 410 (OUTPUT TEMPLATE-N). For example, after knowing the format of an exemplary identity shaping template “You are a {determined based on input}, and your task is to {determined based on input}.”, the evaluator LLM can more properly select the format of the contextual template as “To complete your task, there is some background information you might need to know. This background information is {determined based on input}.” and the format of the few-shot learning template as “To complete the task, I can provide you with some examples.

For example, given input: {determined based on input}, you should output: {determined based on output}, . . . (the number of samples depends on the requirements).” Besides, the format of the output template may include some criteria and some slots to be filled with the evaluation of these criteria, which can be used to determine the format of the task-based testing template, i.e., providing assessment tasks in these criteria. In some embodiments of the present disclosure, the selection of few-shot learning template may be based on the selected identity template and contextual template.

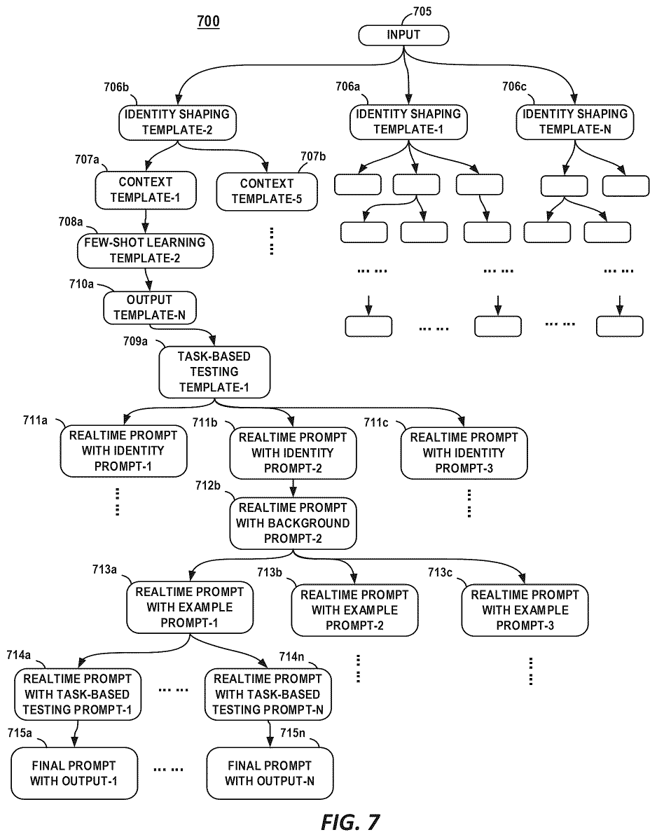

The selected identity template 406 (IDENTITY SHAPING TEMPLATE-2), the selected contextual template 407 (CONTEXT TEMPLATE-1), the selected few-shot learning template 408 (FEW-SHOT LEARNING TEMPLATE-2), the selected task-based testing template 409 (TASK-BASED TESTING TEMPLATE-1) and the selected output template 410 (OUTPUT TEMPLATE-N) may correspond to nodes in a branch of the tree of thoughts. That is, the selection of a prompt template may be interconnected with the preceding selection of a prompt template or the specific domain 402, forming chains of thought that, in turn, shape a tree-like structure composed of multiple thought chains. The selected contextual template 407 (CONTEXT TEMPLATE-1) and the selected few-shot learning template 408 (FEW-SHOT LEARNING TEMPLATE-2) correspond to descendant nodes of the selected identity template 406 (IDENTITY SHAPING TEMPLATE-2), and the selected task-based testing template 409 (TASK-BASED TESTING TEMPLATE-1) may corresponds to a descendant node of the selected output template 410 (OUTPUT TEMPLATE-N). In some embodiments, the selected few-shot learning template 408 (FEW-SHOT LEARNING TEMPLATE-2) may corresponds to a descendant node of the selected contextual template 407 (CONTEXT TEMPLATE-1). An exemplary relationship among the selected templates and the tree of thoughts will be described below in detail with reference to FIG. 7.

In some embodiments, the evaluator LLM 403 may select multiple identity templates from the identity shaping module 306 based on the user query, each identity template of the multiple identity templates may correspond to a branch of the tree of thoughts. Similarly, the evaluator LLM 403 may select multiple contextual templates, multiple few-shot learning templates, multiple task-based testing templates and/or multiple output templates, with different templates correspond to different branches or sub-branches. In some embodiments, the selected identity template 406 (IDENTITY SHAPING TEMPLATE-2), the selected contextual template 407 (CONTEXT TEMPLATE-1), the selected few-shot learning template 408 (FEW-SHOT LEARNING TEMPLATE-2), the selected task-based testing template 409 (TASK-BASED TESTING TEMPLATE-1) and the selected output template 410 (OUTPUT TEMPLATE-N) that may be associated with each other constitute an overall template 411. The prompt templates selected from the plurality of modules may be used to constraint subsequent thoughts of the tree of thoughts.

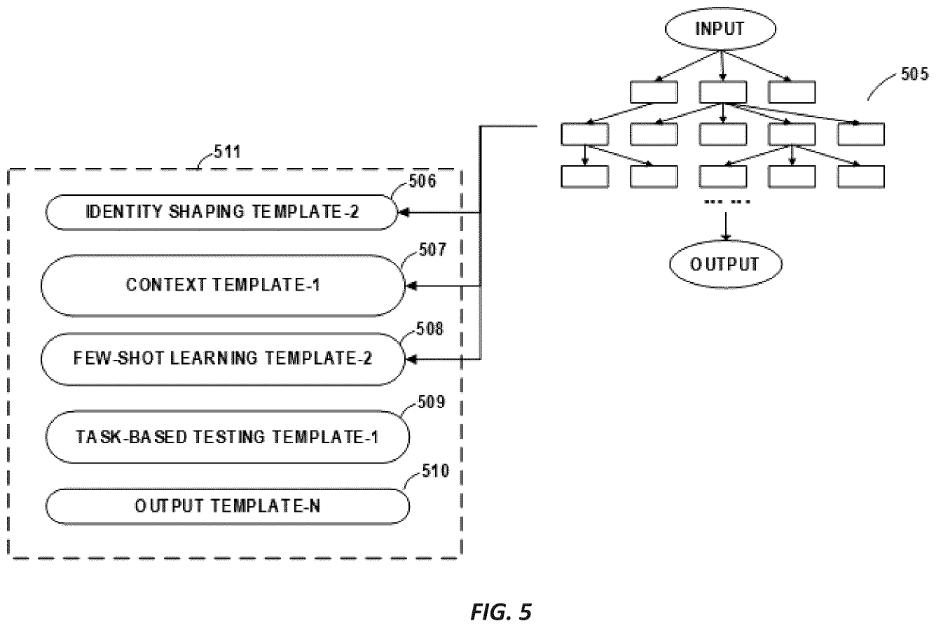

As seen from the FIG. 3 and the descriptions with reference to FIG. 3, each of the prompt templates may include at least one slot to be filled. FIG. 5 shows an exemplary schematic diagram of filling slots of prompt templates according to an embodiment of the present disclosure.

As shown in FIG. 5, once an overall template 411 has been generated, the slots of the prompt templates 506-510 may need to be filled based on specific test scenario. Among these five prompt templates 506-510, slots of the identity template 506 (IDENTITY SHAPING TEMPLATE-2), the contextual template 507 (CONTEXT TEMPLATE-1) and the few-shot learning template 508 (FEW-SHOT LEARNING TEMPLATE-2) may be filled during the generation of the tree of thoughts 505.

The at least one slot (e.g., identity slot and target task slot) of the identity template 506 (IDENTITY SHAPING TEMPLATE-2) may be filled to generate one or more identity prompts. Different identity prompts may represent different thoughts (nodes of different branches) of the tree of thoughts. Similarly, the at least one slot (e.g., background slot) of the contextual template 507 (CONTEXT TEMPLATE-1) may be filled to generate one or more background prompts. The at least one slot (e.g., one or more example slots) of the few-shot learning template 508 (FEW-SHOT LEARNING TEMPLATE-2) may be filled to generate one or more example prompts.

In some embodiments of the present disclosure, filling the contextual template 507 (CONTEXT TEMPLATE-1) and the few-shot learning template 508 (FEW-SHOT LEARNING TEMPLATE-2) may be based on the generated identity prompt, i.e., the filled identity template. In some embodiments, filling the few-shot learning template 508 (FEW-SHOT LEARNING TEMPLATE-2) may be based on the filled identity template and the filled contextual template in the same branch of the tree of thoughts. That is, the filled identity template, contextual template and few-shot learning template that are associated with each other may form a thought chain. With the process of filling the templates 506-508, a real time prompt 511 may be updated. An exemplary relationship among the filled templates (e.g., identity prompt, background prompt, example prompt) and the tree of thoughts will be described below in detail with reference to FIG. 7.

Continuing with the taking a code generation test problem as an example, the filled identity template may be as follows: “You are a {code generation evaluator}, and your task is to {evaluate the quality of a piece of code}.” The filled contextual template may be as follows: “To complete your task, there may be some background information you might need to know. This background information may be {the code itself}.” The filled few-shot learning template may be as follows: “To complete the task, I can provide you with some examples. For example, given input: {input-1, obtained through retrieval or generation}, you should output: {output-2, obtained through retrieval or generation} . . . (the number of samples depends on the requirements).”

The above description with reference to FIG. 5 states that among these five prompt templates 506-510, slots for the identity template 506 (IDENTITY SHAPING TEMPLATE-2), the contextual template 507 (CONTEXT TEMPLATE-1) and the few-shot learning template 508 (FEW-SHOT LEARNING TEMPLATE-2) may be filled during the generation of the tree of thoughts 505. For the task-based testing template 509 (TASK-BASED TESTING TEMPLATE-1) and output template 510 (OUTPUT TEMPLATE-N), the tasks of filling their slots may not be directly solved by the evaluator LLM, for example, utilizing input-output prompting method.

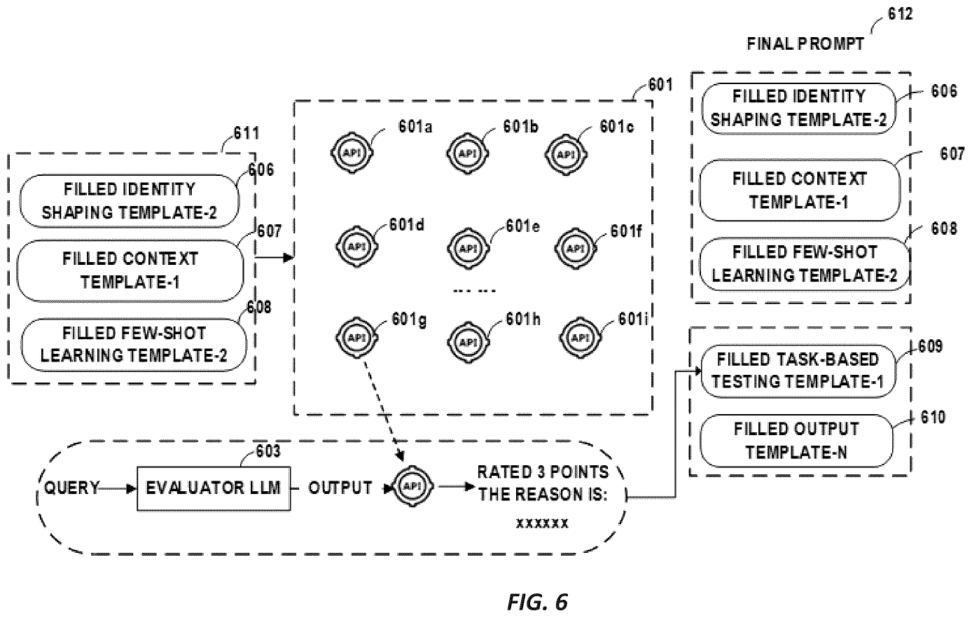

FIG. 6 shows another exemplary schematic diagram of filling slots of prompt templates according to an embodiment of the present disclosure. As shown in FIG. 6, filling the slots of the task-based testing template and output template need a second tree of thoughts for slot filling.

As mentioned above, the filled identity template 606 (FILLED IDENTITY SHAPING TEMPLATE-2), the filled contextual template 607 (FILLED CONTEXT TEMPLATE-1) and the filled few-shot learning template 608 (FILLED FEW-SHOT LEARNING TEMPLATE-2) constitute a real-time prompt 611, which can be deemed as context. The evaluator LLM 603 may generate a second tree of thought by decomposing the task of filling slots of the task-based testing template (i.e., the task of generating the task-based testing prompt) into a plurality of sub-tasks (for example, evaluation sub-tasks) and generating a solution to each of the plurality of sub-tasks based on the context.

In some embodiments of the present disclosure, during the decomposition process, the evaluator LLM 603 may not decompose the task into the plurality of sub-tasks based on selecting tools from a tool pool 601 that already exists. Each sub-task of the plurality of sub-tasks may be accomplished by a tool of the plurality of tools. As shown in FIG. 6, the tool pool 601 refers to a set of specialized APIs (also referred to as tools) 601a, 601b, . . . , 601n providing evaluation services, such as, but not limited to, mathematical accuracy evaluation service, run speed evaluation service, output harmfulness assessment service, green energy-saving evaluation service, output bias evaluation service, triple readability evaluation service, output fluency evaluation service, banking industry risk assessment service, laws and regulations citation evaluation service, amongst other evaluation services.

The evaluator LLM 603 may initially assess whether utilizing APIs from the tool pool 601 is necessary for the evaluation sub-task. If it is not needed to utilize APIs to solve the evaluation sub-task, the evaluator LLM 603 may generate a solution to the evaluation sub-task by itself, for example, based on its own knowledge. If it is needed to utilize APIs to solve the evaluation sub-task, the evaluator LLM 603 genuinely calls these APIs, retrieves specific values, and then encapsulates them into the prompt for return, i.e., filling the slots of the task-based testing template.

The plurality of sub-tasks may comprise sub-tasks of evaluating capabilities of the LLM that answers a user query in different dimensions. The plurality of sub-tasks may comprise a sub-task of generating answers to the user query by the evaluator LLM 603. The slots of the output template may be filled based on the filled task-based testing template 609 (FILLED TASK-BASED TESTING TEMPLATE-1). The filling of the output template 610 (FILLED OUTPUT TEMPLATE-N) may also be achieved during generating the second tree of thoughts. In some embodiments, the filling of the output template may be achieved by means of generating a third tree of thoughts, which is different from the second tree of thoughts that fills the task-based testing template. A final prompt 612 may be generated after filling all the slots.

FIG. 7 shows an exemplary schematic diagram of an example ToT 700 according to an embodiment of the present disclosure.

As shown in FIG. 7, after receiving input 705, the evaluator LLM (similar to the evaluator LLMs 203, 303, 403, 603 described with reference to FIGS. 2-4 and 6) may perform a task of selecting an identity template from an identity repository (e.g., the identity shaping module 306) based on the input 705. The evaluator LLM may select different identity templates 706a, 706b and 706c (i.e., IDENTITY SHAPING TEMPLATE-1, IDENTITY SHAPING TEMPLATE-2, and IDENTITY SHAPING TEMPLATE-N) based on the input 705. These identity templates 706a, 706b and 706c may be solutions to the task of selecting an identity template and may also be nodes of different branches of the tree of thoughts.

After selecting an identity template, the evaluator LLM may perform a task of selecting a contextual template from a contextual repository (e.g., the contextual information module 307) based on the input 705. In some embodiments, the selection of a contextual template may be further based on the selected identity template. After selecting the identity template 706b (IDENTITY SHAPING TEMPLATE-2), the evaluator LLM may select different contextual templates 707a and 707b (CONTEXT TEMPLATE-1 and CONTEXT TEMPLATE-5) based on the input 705. The contextual templates 707a and 707b may be solutions to the task of selecting a contextual template and may also be child nodes of the node corresponding to the identity template 706b (IDENTITY SHAPING TEMPLATE-2). FIG. 7 may not, for the sake of brevity, show details of branches of nodes corresponding to the identity templates 706a and 706c (IDENTITY SHAPING TEMPLATE-1 and IDENTITY SHAPING TEMPLATE-N).

After selecting a contextual template, the evaluator LLM may perform a task of selecting a few-shot learning template from a few-shot learning repository (e.g., the few-shot learning module 308) based on the input 705. Similarly, in some embodiments, the selection of a few-shot learning template may be further based on the selected identity template and the selected contextual template. After selecting the contextual template 707a (CONTEXT TEMPLATE-1), the evaluator LLM may select the few-shot learning template 708a (FEW-SHOT LEARNING TEMPLATE-2). The few-shot learning template 708a (FEW-SHOT LEARNING TEMPLATE-2) may be a solution to the task of selecting a few-shot learning template and may also be a child node of the node corresponding to the contextual template 707a (CONTEXT TEMPLATE-1), and thus may be a grandchild node of the node corresponding to the identity template 706b (IDENTITY SHAPING TEMPLATE-2).

After selecting a few-shot learning template, the evaluator LLM may perform a task of selecting an output template from an output repository (e.g., the output module 310) based on the input 705. As shown in FIG. 7, after selecting the few-shot learning template 708a (FEW-SHOT LEARNING TEMPLATE-2), the evaluator LLM selects the output template 710a (OUTPUT TEMPLATE-N). Similarly, the output template 710a (OUTPUT TEMPLATE-N) may be a solution to the task of selecting an output template and may also be a child node of the node corresponding to the few-shot learning template 708a (FEW-SHOT LEARNING TEMPLATE-2).

After selecting an output template, the evaluator LLM may perform a task of selecting a task-based testing template from a task-based testing repository (e.g., the task-based testing module 309) based on the selected output template. As shown in FIG. 7, after selecting the output template 710a (OUTPUT TEMPLATE-N), the evaluator LLM selects the task-based testing template 709a (TASK-BASED TESTING TEMPLATE-1). Similarly, the task-based testing template 709a (TASK-BASED TESTING TEMPLATE-1) may be a solution to the task of selecting a task-based testing template and may also be a child node of the node corresponding to the output template 710a (OUTPUT TEMPLATE-N).

The identity template 706b (IDENTITY SHAPING TEMPLATE-2), the contextual template 707a (CONTEXT TEMPLATE-1), the few-shot learning template 708a (FEW-SHOT LEARNING TEMPLATE-2), the output template 710a (OUTPUT TEMPLATE-N), and the task-based testing template 709a (TASK-BASED TESTING TEMPLATE-1) may be in the same branch of the tree of thoughts, and they constitute an overall template.

Furthermore, after selecting the overall template, the evaluator LLM may perform a task of filling the at least one slot (e.g., identity slot and target task slot) of the identity template 706b (IDENTITY SHAPING TEMPLATE-2) in the overall template to generate a real time prompt with an identity prompt. As shown in FIG. 7, the evaluator LLM may fill the at least one slot of the identity template 706b (IDENTITY SHAPING TEMPLATE-2) with different contents, so as to generate different real time prompts with different identity prompts 711a, 711b and 711c (REALTIME PROMPT WITH IDENTITY PROMPT-1, REALTIME PROMPT WITH IDENTITY PROMPT-2, REALTIME PROMPT WITH IDENTITY PROMPT-3). The real time prompts with different identity prompts 711a, 711b and 711c may be solutions to the task of filling the at least one slot of the identity template 706b (IDENTITY SHAPING TEMPLATE-2) and are also child nodes of the node corresponding to the task-based testing template 709a (TASK-BASED TESTING TEMPLATE-1), and may belong to different branches, respectively.

After generating real time prompt with the identity prompt 711b (REALTIME PROMPT WITH IDENTITY PROMPT-2), the evaluator LLM may perform a task of filling the at least one slot (e.g., background slot) of the contextual template 707a (CONTEXT TEMPLATE-1) in the overall template to generate a background prompt, such that the real time prompt may be updated with the background prompt. As shown in FIG. 7, the evaluator LLM fills the at least one slot of the contextual template 707a (CONTEXT TEMPLATE-1) to generate the real time prompt with the background prompt 712b (REALTIME PROMPT WITH BACKGROUND PROMPT-2). The real time prompt with the background prompt 712b (REALTIME PROMPT WITH BACKGROUND PROMPT-2) may be a solution to the task of filling the at least one slot of the contextual template 707a (CONTEXT TEMPLATE-1) and may also a child node of the node corresponding to the real time prompt with the identity prompt 711b (REALTIME PROMPT WITH IDENTITY PROMPT-2).

After generating the real time prompt with the background prompt 712b (REALTIME PROMPT WITH BACKGROUND PROMPT-2), the evaluator LLM may perform a task of filling the at least one slot (e.g., one or more example slots) of the few-shot learning template 708a (FEW-SHOT LEARNING TEMPLATE-2) in the overall template to generate an example prompt, such that the real time prompt is updated with the example prompt. As shown in FIG. 7, the evaluator LLM may fill the at least one slot of the few-shot learning template 708a (FEW-SHOT LEARNING TEMPLATE-2) with different example prompts, so as to generate different real time prompts with different example prompts 713a, 713b and 713c (REALTIME PROMPT WITH EXAMPLE PROMPT-1, REALTIME PROMPT WITH EXAMPLE PROMPT-2, REALTIME PROMPT WITH EXAMPLE PROMPT-3). The real time prompts with different example prompts 713a, 713b and 713c may be solutions to the task of filling the at least one slot of the few-shot learning template 708a (FEW-SHOT LEARNING TEMPLATE-2) and may also be child nodes of the node corresponding to the real time prompt with the background prompt 712b (REALTIME PROMPT WITH BACKGROUND PROMPT-2).

After generating the real time prompt with the example prompt 713a (REALTIME PROMPT WITH EXAMPLE PROMPT-1), the evaluator LLM may perform a task of filling the slots of the task-based testing template 709a (TASK-BASED TESTING TEMPLATE-1) in the overall template to generate a task-based testing prompt, such that the real time prompt may be updated with the task-based testing prompt. As shown in FIG. 7, the evaluator LLM may fill the slots of the few-shot learning template 708a (FEW-SHOT LEARNING TEMPLATE-2) with different contents, so as to generate different real time prompts with different task-based testing prompts 714a, . . . , 714n (REALTIME PROMPT WITH TASK-BASED TESTING PROMPT-1, . . . , REALTIME PROMPT WITH TASK-BASED TESTING PROMPT-N). The real time prompts with different task-based testing prompts 714a, . . . , 714n are solutions to the task of filling the at least one slot of the task-based testing template 709a (TASK-BASED TESTING TEMPLATE-1) and are also child nodes of the node corresponding to the real time prompt with the example prompt 713a (REALTIME PROMPT WITH EXAMPLE PROMPT-1).

After generating the real time prompt with a task-based testing prompt, the evaluator LLM may perform a task of filling the slots of the output template 710a (OUTPUT TEMPLATE-N) in the overall template based on the task-based testing prompt, so as to generate a final prompt. As shown in FIG. 7, the evaluator LLM generates final prompts 715a, . . . , 715n (FINAL PROMPT WITH OUTPUT-1, . . . , FINAL PROMPT WITH OUTPUT-N) based on the real time prompts with different task-based testing prompts 714a, . . . , 714n, respectively.

The identity template 706b (IDENTITY SHAPING TEMPLATE-2), the contextual template 707a (CONTEXT TEMPLATE-1), the few-shot learning template 708a (FEW-SHOT LEARNING TEMPLATE-2), the output template 710a (OUTPUT TEMPLATE-N), the task-based testing template 709a (TASK-BASED TESTING TEMPLATE-1), the real time prompt with the identity prompt 711b (REALTIME PROMPT WITH IDENTITY PROMPT-2), the real time prompt with the background prompt 712b (REALTIME PROMPT WITH BACKGROUND PROMPT-2), the real time prompt with the example prompt 713a (REALTIME PROMPT WITH EXAMPLE PROMPT-1), the task-based testing prompt 714a (REALTIME PROMPT WITH TASK-BASED TESTING PROMPT-1), and the final prompt 715a (FINAL PROMPT WITH OUTPUT-1) constitute a thought chain (a branch). Multiple thought chains may constitute a tree of thoughts.

It should be appreciated that FIG. 7 is illustrated as only one example and is not meant to be seen as limiting to the present invention, other examples may be suitable. In some embodiments, once a template of a first type has been selected, it can be filled before selecting templates of other types, for example, once an identity template has been selected, it can be filled before selecting contextual template, few-shot learning template, task-based testing template and output template. In an example, the real time prompt with the identity prompt 711b (REALTIME PROMPT WITH IDENTITY PROMPT-2) may be the child node of the identity template 706b (IDENTITY SHAPING TEMPLATE-2), the contextual template 707a (CONTEXT TEMPLATE-1) may be the child node of the real time prompt with the identity prompt 711b (REALTIME PROMPT WITH IDENTITY PROMPT-2), and the real time prompt with the background prompt 712b (REALTIME PROMPT WITH BACKGROUND PROMPT-2) may be the child node of the contextual template 707a (CONTEXT TEMPLATE-1).

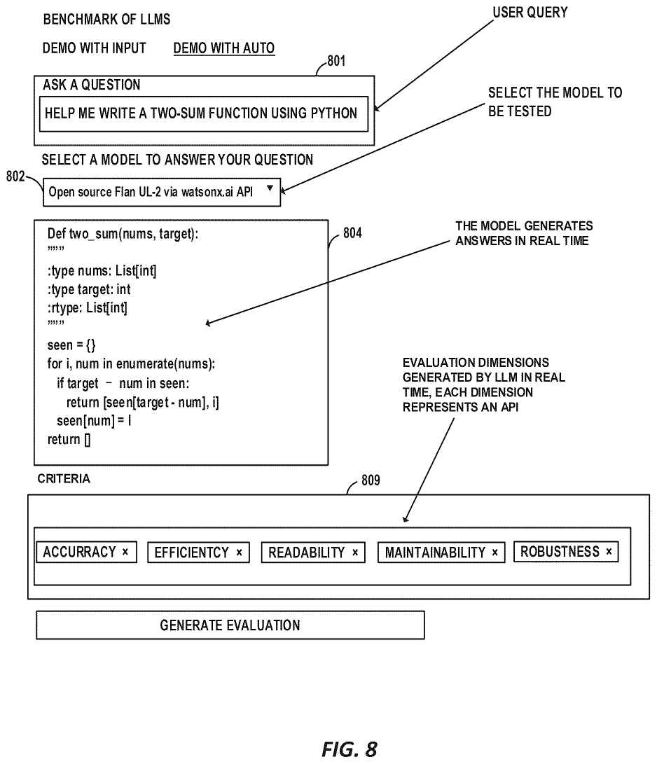

FIG. 8 shows an exemplary schematic diagram of model evaluation interface in an example of instruction generation according to an embodiment of the present disclosure.

As shown in FIG. 8, a user enters a query into a user query box 801, such as, but not limited to “Help me write a two-sum function using python” in the user query box 801 and may select the model to be tested in the model selection box 802. Then, the model may generate answers in real time and shows them in the answer box 804. Based on the entered query, several evaluation dimensions generated by an evaluator LLM in real time are presented in the criteria box 809. Each evaluation dimension may represent an API. In the example shown in FIG. 8, the evaluation dimensions comprise accuracy (code accuracy), efficiency (code efficiency), readability (code readability), maintainability (code maintainability), and robustness (code robustness), however this example is not meant to be seen as limiting to the present invention.

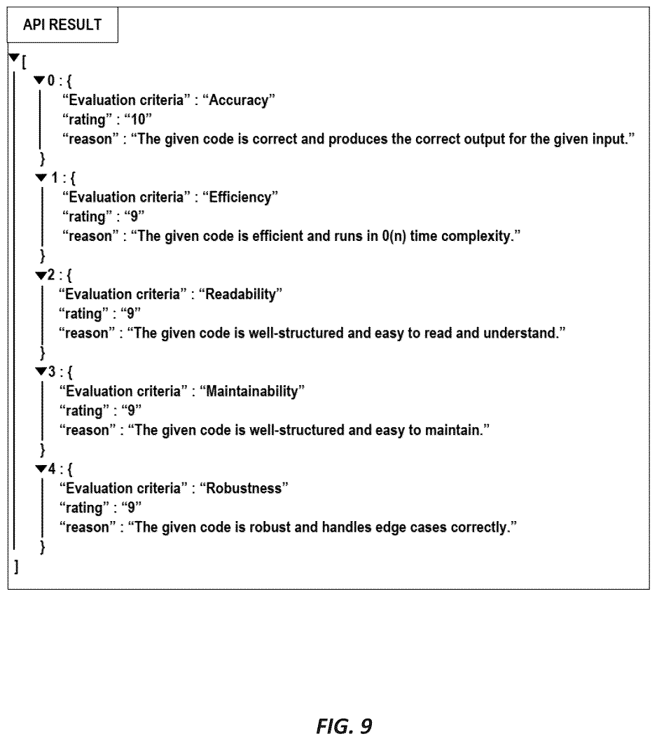

FIG. 9 shows an exemplary schematic diagram of results in the evaluation dimensions of FIG. 8. As shown in FIG. 9, for each evaluation criterion, a rating and reason for the rating may be generated, for example by a corresponding API. In some embodiments, the output template 410, 510 may be filled to generate the results in the evaluation dimensions, and the evaluator LLMs 303, 403, 603 may combine and summarize these results to output an evaluation report. For example, the evaluation report for the results in the evaluation dimensions shown in FIG. 9 may be as follows: “Finally, after carefully consideration, we concluded that: This answer is accurate, efficient, readable, maintainable, and robust. It produces the correct output for the given input and runs in O(n) time complexity. The code is well-structured and easy to read, maintain, and handle edge cases correctly.” In some other embodiments, the output of the tree of thoughts 205, 505 generate the evaluation report, which may then be outputted by the evaluator LLMs 303, 403, 603.

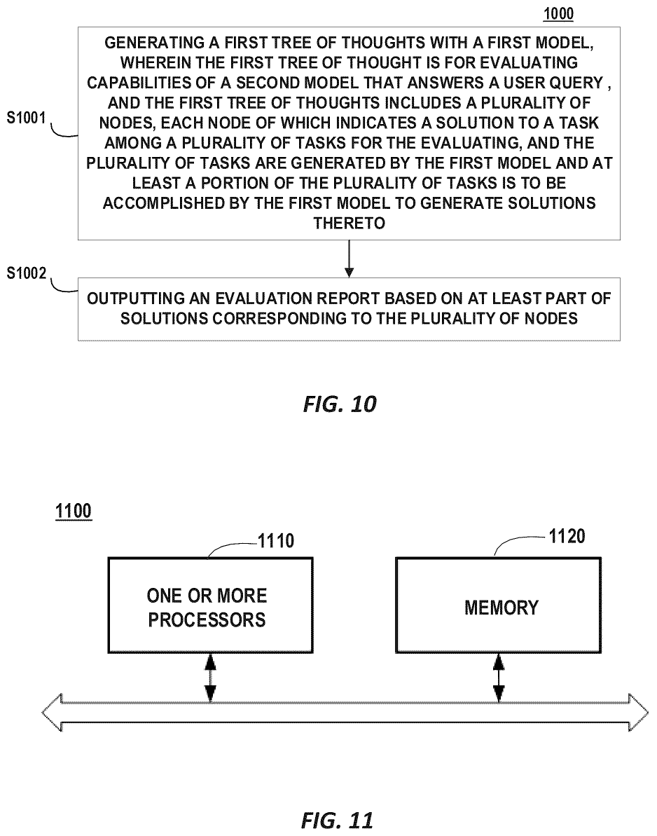

FIG. 10 shows a flowchart of a computer-implemented method 900 of model evaluation according to an embodiment of the present disclosure. The detailed description of method 1000 can refer to the content described in the above with respect to FIGS. 1-9. Each step of method 1000 can be performed by one or more processors/processing units, such as central processing unit (CPU).

With reference to FIG. 10, method 1000 comprises steps S1001-S1002.

At step S1001, a first tree of thoughts for evaluating capabilities of a second model that answers a user query may be generated by a first model. The first model may be substantially similar to an evaluator LLMs 203, 303, 403, 603 as described with reference to FIGS. 2-4 and 6. The first model may also be referred to as an evaluating model.

The second model may refer to the model to be evaluated, for example LLM 202 as described with reference to FIG. 2, and may also be referred to as the model to be tested. The first tree of thoughts may include a plurality of nodes, each node of which indicates a solution to a task among a plurality of tasks for the evaluating, and the plurality of tasks are generated by the first model and at least a portion of the plurality of tasks which may be accomplished by the first model to generate solutions thereto (e.g., accomplished by solutions generated by the first model). In cases which the first model may not be capable/incapable of accomplishing a first task among the plurality of tasks independently, a tool may be invoked by the first model from a tool pool to generate a first solution to the first task. The tool pool may be substantially similar to the service pool 206 as described with reference to FIG. 2 and the tool pool 601 as described with reference to FIG. 6. The tools may be substantially similar to the service 206a-206b as described with reference to FIG. 2 and specialized APIs 601a, 601b, . . . , 601n as described with reference to FIG. 6.

At step S1002, an evaluation report may be outputted based on at least part of solutions corresponding to the plurality of nodes. The evaluation report may be substantially similar to the result 207 as described with reference to FIG. 2 and the evaluation report as described with reference to FIG. 9.

According to embodiments of the present disclosure, generating a first tree of thoughts may comprise: selecting a prompt template from each of multiple template repositories of different types, wherein each selected prompt template includes at least one slot corresponding to a task for generating a prompt; filling the at least one slot to generate a prompt. Selecting a prompt template and filling the at least one slot each may be a task of the plurality of tasks. The selected prompt template and the generated prompt may act as nodes in a branch of the first tree of thoughts with the generated prompt acting as a descendant node of the selected prompt template. The prompt template may be substantially similar to the prompt templates 406-410, 506-510 as described with reference to FIGS. 4-5. The slot may be substantially similar to the slots as described with reference to FIG. 3.

According to embodiments of the present disclosure, selecting a prompt template from each of multiple template repositories of different types may comprise: selecting an identity template from an identity repository, the identity template including an identity slot and a target task slot; selecting a contextual template from a contextual repository, the contextual template including a background slot; selecting a few-shot learning template from a few-shot learning repository, the few-shot learning template including one or more example slots for providing one or more input-output examples; selecting an output template from an output repository, the output template including one or more output slots for providing an evaluation result; and selecting a task-based testing template from a task-based testing repository, the task-based testing template providing multiple tasks to be accomplished and including one or more testing result slots for providing testing results of the multiple tasks. The selected identity template, the selected contextual template, the selected few-shot learning template, the selected output template, and the selected task-based testing template may act as nodes of the first tree of thoughts. In some embodiments, the evaluation result may refer to the final outputted evaluation report. In other embodiments, the evaluation result may refer to an output with the results in various evaluation dimensions as described with reference to FIG. 9.

The selected contextual template and the selected few-shot learning template may act as descendant nodes of the selected identity template, and the selected task-based testing template may act as a descendant node of the selected output template. The descendant node refers to that the selected contextual template may act as a child node of the selected identity template and may act as a grandchild node, great-grandchild node, later generation node of the selected identity template. In some examples, the selected few-shot learning template may act as a descendant node of the selected contextual template. In some examples, as described with reference FIG. 4, the selection of contextual template and the selection of few-shot learning template may be based on the selected identity template, and the selection of task-based testing template may be based on the selected output template.

According to embodiments of the present disclosure, filling the at least one slot may comprise: filling the identity slot and the target task slot of the selected identity template to generate an identity prompt; filling the background slot of the selected contextual template to generate a background prompt; and filling the one or more example slots of the selected few-shot learning template to generate an example prompt. The generated identity prompt, the generated background prompt and the generated example prompt may act as nodes of the first tree of thoughts, and the generated background prompt and the generated example prompt may act as descendant nodes of the generated identity prompt. In some examples, the generated example prompt may act as a descendant node of the generated background prompt. Filling the identity template, the contextual template and the few-shot learning template may be substantially similar to the filling process as described with reference to FIG. 5.

In some embodiments, the identity template, the contextual template, the few-shot learning template, the task-based testing template, and the output template may be filled after an overall template, for example the overall template 411 in FIG. 4, has been constituted, i.e., all of identity template, contextual template, few-shot learning template, task-based testing template and output template has been selected. In other embodiments, once a template of a first type has been selected, it can be filled before selecting templates of other types, for example, once an identity template has been selected, it can be filled before selecting contextual template, few-shot learning template, task-based testing template and output template. In other words, the generated identity prompt may be a child node of the selected identity template, rather than a child node of the last selected template for constituting the overall template.

In some embodiments, the generated identity prompt, background prompt, example prompt each may refer to a single prompt and alternatively may constitute an overall prompt, for example a real-time prompt. The real-time prompt may refer to that it is updated when a background prompt is generated and when an example prompt is generated.

According to embodiments of the present disclosure, filling the at least one slot may further comprise filling the one or more testing result slots of the selected task-based testing template to generate a task-based testing prompt. The task-based testing prompt corresponds to a descendant node of the generated identity prompt, background prompt and example prompt.

According to embodiments of the present disclosure, filling the one or more testing result slots of the selected task-based testing template may comprise in response to the first model being not capable/incapable of accomplishing a task of generating the task-based testing prompt independently, generating a second tree of thoughts by decomposing the task of generating the task-based testing prompt into a plurality of sub-tasks and generating a solution to each of the plurality of sub-tasks. The generation of the second tree of thoughts may be substantially similar to the process of generating the second tree of thoughts as described with reference to FIG. 6.

According to embodiments of the present disclosure, decomposing a task of generating the task-based testing prompt into a plurality of sub-tasks is based on selecting a plurality of tools from the tool pool, and each sub-task of the plurality of sub-tasks is accomplished by a tool of the plurality of tools to generate a solution to the sub-task. According to embodiments of the present disclosure, a solution to a first sub-task of the plurality of sub-tasks is generated by invoking a tool from the tool pool. The tool pool may be substantially similar to the tool pool 601 as described with reference to FIG. 6. It should be appreciated that some of the plurality of sub-tasks may be accomplished by the first model. Thus, according to embodiments of the present disclosure, a solution to a second sub-task of the plurality of sub-tasks is generated by the first model.

According to embodiments of the present disclosure, outputting the evaluation report may comprise filling the one or more output slots of the selected output template to generate an output prompt based on the task-based testing prompt. In some embodiments, the output prompt is an output with the results in various evaluation dimensions as described with reference to FIG. 9. In other embodiments, outputting the evaluation report may further comprise generate the evaluation report based on the output prompt.

According to embodiments of the present disclosure, method 900 may further comprise steps of determining a domain to which the second model belongs based on the user query and selecting a prompt template from each of multiple template repositories of different types is based on the domain. The domain may be substantially similar to the domain 402 as described with reference to FIG. 4. In some embodiments, the user query may comprise one or more of text, image, sound, or video.

FIG. 11 shows a system 1100 of model evaluation according to an embodiment of the present disclosure. The system 1100 of model evaluation comprises one or more processors 1110 and a memory 1120 coupled to at least one of the processors 1110. A set of computer program instructions are stored in the memory 1120. When executed by at least one of the processors 1110, the set of computer program instructions perform following series of actions. A first tree of thoughts for evaluating capabilities of a second model that answers a user query is generated by a first model. The first tree of thoughts includes a plurality of nodes, each node of which indicates a solution to a task among a plurality of tasks for the evaluating, and the plurality of tasks are generated by the first model and at least a portion of the plurality of tasks is to be accomplished by the first model to generate solutions thereto (e.g., accomplished by solutions generated by the first model). In response to the first model being not capable/incapable of accomplishing a first task among the plurality of tasks independently, a tool is invoked from a tool pool by the first model to generate a first solution to the first task. An evaluation report is outputted based on at least part of solutions corresponding to the plurality of nodes.

In some embodiments, the set of computer program instructions for generating a first tree of thoughts may comprise a set of computer program instructions that perform actions of selecting a prompt template from each of multiple template repositories of different types, wherein each selected prompt template includes at least one slot corresponding to a task for generating a prompt; and filling the at least one slot to generate a prompt. Selecting a prompt template and filling the at least one slot each may be a task of the plurality of tasks. In an example, the selected prompt template and the generated prompt may act as nodes in a branch of the first tree of thoughts with the generated prompt acting as a descendant node of the selected prompt template.

In some embodiments, the set of computer program instructions for selecting a prompt template from each of multiple template repositories of different types may comprise a set of computer program instructions that perform actions of selecting an identity template from an identity repository, the identity template including an identity slot and a target task slot; selecting a contextual template from a contextual repository, the contextual template including a background slot; selecting a few-shot learning template from a few-shot learning repository, the few-shot learning template including one or more example slots for providing one or more input-output examples; selecting an output template from an output repository, the output template including one or more output slots for providing an evaluation result; and selecting a task-based testing template from a task-based testing repository, the task-based testing template providing multiple tasks to be accomplished and including one or more testing result slots for providing testing results of the multiple tasks. The selected identity template, the selected contextual template, the selected few-shot learning template, the selected output template, and the selected task-based testing template may act as nodes of the first tree of thoughts.

In an example, the selected contextual template and the selected few-shot learning template may act as descendant nodes of the selected identity template, and the selected task-based testing template may act as a descendant node of the selected output template. In an example, the selected few-shot learning template may act as a descendant node of the selected contextual template.

In some embodiments, the set of computer program instructions for filling the at least one slot may comprise a set of computer program instructions that perform actions of filling the identity slot and the target task slot of the selected identity template to generate an identity prompt; filling the background slot of the selected contextual template to generate a background prompt; and filling the one or more example slots of the selected few-shot learning template to generate an example prompt. The generated identity prompt, the generated background prompt, and the generated example prompt may act as nodes of the first tree of thoughts.

In an example, the generated background prompt and the generated example prompt may act as descendant nodes of the generated identity prompt. In an example, the generated example prompt may act as a descendant node of the generated background prompt.

In some embodiments, the set of computer program instructions for filling the at least one slot may further comprise a set of computer program instructions that perform an action of filling the one or more testing result slots of the selected task-based testing template to generate a task-based testing prompt. In an example, the task-based testing prompt may act as a descendant node of the generated identity prompt, background prompt and example prompt.

In some embodiments, the set of computer program instructions for filling the one or more testing result slots of the selected task-based testing template may comprise a set of computer program instructions that perform an action of in response to the first model being not capable of accomplishing a task of generating the task-based testing prompt independently, generating a second tree of thoughts by decomposing the task of generating the task-based testing prompt into a plurality of sub-tasks and generating a solution to each of the plurality of sub-tasks.

In some embodiments, decomposing a task of generating the task-based testing prompt into a plurality of sub-tasks is based on selecting a plurality of tools from the tool pool, and each sub-task of the plurality of sub-tasks is accomplished by a tool of the plurality of tools to generate a solution to the sub-task.

In some embodiments, a solution to a first sub-task of the plurality of sub-tasks is generated by invoking a tool from the tool pool.

In some embodiments, a solution to a second sub-task of the plurality of sub-tasks is generated by the first model.

In some embodiments, the set of computer program instructions for outputting the evaluation report may comprise a set of computer program instructions that perform an action of filling the one or more output slots of the selected output template to generate an output prompt based on the task-based testing prompt. In some embodiments, the output prompt per se may be the evaluation report. In other embodiments, the set of computer program instructions for outputting the evaluation report may comprise a set of computer program instructions that perform an action of generating the evaluation report based on the generated output prompt.

In some embodiments, the set of computer program instructions may further comprise a set of computer program instructions that perform an action of determining a domain to which the second model belongs based on the user query. In an example, selecting a prompt template from each of multiple template repositories of different types is based on the domain.

In some embodiments, the user query may comprise one or more of text, image, sound, or video.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for model evaluation, comprising:
generating a first tree of thoughts with a first model, wherein the first tree of thoughts is for evaluating capabilities of a second model that answers a user query, and the first tree of thoughts includes a plurality of nodes, each node of which indicates a solution to a task among a plurality of tasks for the evaluating, and the plurality of tasks are generated by the first model and at least a portion of the plurality of tasks is to be accomplished by solutions generated by the first model;
invoking a tool from a tool pool, wherein the tool is invoked in response to determining the first model is incapable of accomplishing a first task of the plurality of tasks independently; and
outputting an evaluation report based on at least part of solutions corresponding to the plurality of nodes.

2. The computer-implemented method of claim 1, wherein generating the first tree of thoughts comprises:
selecting a prompt template from each of multiple template repositories of different types, wherein each selected prompt template includes at least one slot corresponding to a task for generating a prompt; and
filling the at least one slot to generate a prompt, wherein selecting a prompt template and filling the at least one slot each is a task of the plurality of tasks, and the selected prompt template and the generated prompt act as nodes in a branch of the first tree of thoughts with the generated prompt acting as a descendant node of the selected prompt template.

3. The computer-implemented method of claim 2, wherein selecting the prompt template from each of multiple template repositories of different types comprises:
selecting an identity template from an identity repository, the identity template including an identity slot and a target task slot;
selecting a contextual template from a contextual repository, the contextual template including a background slot;
selecting a few-shot learning template from a few-shot learning repository, the few-shot learning template including one or more example slots for providing one or more input-output examples;
selecting an output template from an output repository, the output template including one or more output slots for providing an evaluation result; and
selecting a task-based testing template from a task-based testing repository, the task-based testing template providing multiple tasks to be accomplished and including one or more testing result slots for providing testing results of the multiple tasks.

4. The computer-implemented method of claim 3, wherein the selected contextual template and the selected few-shot learning template act as descendant nodes of the selected identity template, and the selected task-based testing template acts as a descendant node of the selected output template.

5. The computer-implemented method of claim 3, wherein filling the at least one slot comprises:
filling the identity slot and the target task slot of the selected identity template to generate an identity prompt;
filling the background slot of the selected contextual template to generate a background prompt;
filling the one or more example slots of the selected few-shot learning template to generate an example prompt; and
filling the one or more testing result slots of the selected task-based testing template to generate a task-based testing prompt,
wherein the generated identity prompt, the generated background prompt, and the generated example prompt act as nodes of the first tree of thoughts, and the generated background prompt and the generated example prompt act as descendant nodes of the generated identity prompt, and the task-based testing prompt acts as a descendant node of the generated identity prompt, background prompt and example prompt.

6. The computer-implemented method of claim 5, wherein filling the one or more testing result slots of the selected task-based testing template comprises:
generating, in response to the first model being not capable of accomplishing a task of generating the task-based testing prompt independently, a second tree of thoughts by decomposing the task of generating the task-based testing prompt into a plurality of sub-tasks and generating a solution to each of the plurality of sub-tasks.

7. The computer-implemented method of claim 6, wherein decomposing a task of generating the task-based testing prompt into a plurality of sub-tasks is based on selecting a plurality of tools from the tool pool, and each sub-task of the plurality of sub-tasks is accomplished by a tool of the plurality of tools to generate a solution to the sub-task.

8. The computer-implemented method of claim 6, wherein a solution to a first sub-task of the plurality of sub-tasks is generated by invoking a tool from the tool pool.

9. The computer-implemented method of claim 8, wherein a solution to a second sub-task of the plurality of sub-tasks is generated by the first model.

10. The computer-implemented method of claim 5, wherein outputting the evaluation report comprises:
filling the one or more output slots of the selected output template to generate an output prompt based on the task-based testing prompt.

11. The computer-implemented method of claim 1, wherein the user query comprises one or more of text, image, sound, or video.

12. A computer system for model evaluation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating, by a first model, a first tree of thoughts for evaluating capabilities of a second model that answers a user query, wherein the first tree of thoughts includes a plurality of nodes, each node of which indicates a solution to a task among a plurality of tasks for the evaluating, and the plurality of tasks are generated by the first model and at least a portion of the plurality of tasks is to be accomplished solutions generated by the first model;
invoking a tool from a tool pool, wherein the tool is invoked in response to determining the first model is incapable of accomplishing a first task of the plurality of tasks independently; and
outputting an evaluation report based on at least part of solutions corresponding to the plurality of nodes.

13. The computer system of claim 12, wherein the program instructions for generating the first tree of thoughts further comprises:
program instructions, stored on at least one of the one or more computer-readable storage media for execution by at least one of the one or more processors via at least one of the one or more memories, to select a prompt template from each of multiple template repositories of different types, wherein each selected prompt template includes at least one slot corresponding to a task for generating a prompt; and
program instructions, stored on at least one of the one or more computer-readable storage media for execution by at least one of the one or more processors via at least one of the one or more memories, to fill the at least one slot to generate a prompt,
wherein selecting a prompt template and filling the at least one slot each is a task of the plurality of tasks, and the selected prompt template and the generated prompt act as nodes in a branch of the first tree of thoughts with the generated prompt acting as a descendant node of the selected prompt template.

14. The computer system of claim 13, wherein the program instructions for selecting the prompt template from each of multiple template repositories of different types further comprises:
program instructions, stored on at least one of the one or more computer-readable storage media for execution by at least one of the one or more processors via at least one of the one or more memories, to select an identity template from an identity repository, the identity template including an identity slot and a target task slot;
program instructions, stored on at least one of the one or more computer-readable storage media for execution by at least one of the one or more processors via at least one of the one or more memories, to select a contextual template from a contextual repository, the contextual template including a background slot;
program instructions, stored on at least one of the one or more computer-readable storage media for execution by at least one of the one or more processors via at least one of the one or more memories, to select a few-shot learning template from a few-shot learning repository, the few-shot learning template including one or more example slots for providing one or more input-output examples;
program instructions, stored on at least one of the one or more computer-readable storage media for execution by at least one of the one or more processors via at least one of the one or more memories, to select an output template from an output repository, the output template including one or more output slots for providing an evaluation result; and
program instructions, stored on at least one of the one or more computer-readable storage media for execution by at least one of the one or more processors via at least one of the one or more memories, to select a task-based testing template from a task-based testing repository, the task-based testing template providing multiple tasks to be accomplished and including one or more testing result slots for providing testing results of the multiple tasks.

15. The computer system of claim 14, wherein the selected contextual template and the selected few-shot learning template act as descendant nodes of the selected identity template, and the selected task-based testing template acts as a descendant node of the selected output template.

16. The computer system of claim 14, wherein the program instructions to fill the at least one slot to generate the prompt further comprises:
program instructions, stored on at least one of the one or more computer-readable storage media for execution by at least one of the one or more processors via at least one of the one or more memories, to fill the identity slot and the target task slot of the selected identity template to generate an identity prompt;
program instructions, stored on at least one of the one or more computer-readable storage media for execution by at least one of the one or more processors via at least one of the one or more memories, to fill the background slot of the selected contextual template to generate a background prompt;
program instructions, stored on at least one of the one or more computer-readable storage media for execution by at least one of the one or more processors via at least one of the one or more memories, to fill the one or more example slots of the selected few-shot learning template to generate an example prompt; and
program instructions, stored on at least one of the one or more computer-readable storage media for execution by at least one of the one or more processors via at least one of the one or more memories, to fill the one or more testing result slots of the selected task-based testing template to generate a task-based testing prompt,
wherein the generated identity prompt, the generated background prompt, and the generated example prompt act as nodes of the first tree of thoughts, and the generated background prompt and the generated example prompt act as descendant nodes of the generated identity prompt, and the task-based testing prompt acts as a descendant node of the generated identity prompt, background prompt and example prompt.

17. The computer system of claim 16, wherein the program instructions to fill the one or more testing result slots of the selected task-based testing template further comprises:
program instructions, stored on at least one of the one or more computer-readable storage media for execution by at least one of the one or more processors via at least one of the one or more memories, to generate, in response to the first model being not capable of accomplishing a task of generating the task-based testing prompt independently, a second tree of thoughts by decomposing the task of generating the task-based testing prompt into a plurality of sub-tasks and generating a solution to each of the plurality of sub-tasks.

18. The computer system of claim 17, wherein decomposing a task of generating the task-based testing prompt into a plurality of sub-tasks is based on selecting a plurality of tools from the tool pool, and each sub-task of the plurality of sub-tasks is accomplished by a tool of the plurality of tools to generate a solution to the sub-task.

19. The computer system of claim 16, wherein the outputting of the evaluation report further comprises:
program instructions, stored on at least one of the one or more computer-readable storage media for execution by at least one of the one or more processors via at least one of the one or more memories, to fill the one or more output slots of the selected output template to generate an output prompt based on the task-based testing prompt.

20. A computer program product for model evaluation, comprising:
one or more computer readable storage media, and program instructions collectively stored on the one or more computer readable storage media, the program instructions comprising:
generate, by a first model, a first tree of thoughts for evaluating capabilities of a second model that answers a user query, wherein the first tree of thoughts includes a plurality of nodes, each node of which indicates a solution to a task among a plurality of tasks for the evaluating, and the plurality of tasks are generated by the first model and at least a portion of the plurality of tasks is to be accomplished solutions generated by the first model;
invoking a tool from a tool pool, wherein the tool is invoked in response to determining the first model is incapable of accomplishing a first task of the plurality of tasks independently; and
outputting an evaluation report based on at least part of solutions corresponding to the plurality of nodes.
